(19) United States
(12) Patent Application Publication
(10) Pub. No.: US 2016/0038939 A1
(43) Pub. Date: Feb. 11, 2016

(54) MICROFLUIDIC DEVICE

(71) Applicant: SAMSUNG ELECTRONICS CO., LTD., Suwon-si (KR)

(72) Inventors: Jung Ki MIN, Yongin-si (KR); Yong Hyun KIM, Seongnam-si (KR); Seung Jun LEE, Yongin-si (KR); Young Goun LEE, Seoul (KR); Jong Gun LEE, Yongin-si (KR)

(73) Assignee: SAMSUNG ELECTRONICS CO., LTD., Suwon-si (KR)

(21) Appl. No.: 14/747,721

(22) Filed: Jun. 23, 2015

(30) Foreign Application Priority Data
Aug. 8, 2014 (KR) 10-2014-0102475

(51) Int. Cl. B01L 3/00

(52) U.S. Cl. CPC B01L 3/50273; B01L 2400/0409; B01L 2200/10; B01L 2300/041; B01L 2300/161; B01L 2300/069

(57) ABSTRACT

Provided is a microfluidic device having a structure in which scattering of a sample can be prevented. The microfluidic device includes: a platform including: a sample injection hole, at least one chamber configured to accommodate a sample introduced through the sample injection hole, at least one channel connected to the at least one chamber; and a cover disposed over the sample injection hole, wherein a gap is disposed between the sample injection hole and the cover.

### CROSS-REFERENCE TO RELATED APPLICATION

This application claims priority from Korean Patent Application No. 10-2014-0102475, filed on Aug. 8, 2014 in the Korean Intellectual Property Office, the disclosure of which is incorporated herein by reference.

### BACKGROUND

1. Field

Apparatuses consistent with exemplary embodiments relate to a microfluidic device, and more particularly, to a microfluidic device having an improved structure in which scattering of a sample can be prevented.

2. Description of the Related Art

In general, a device that is used to perform a biological or chemical reaction by manipulating a small amount of fluid, is referred to as a microfluidic device. A microfluidic device includes a microfluidic structure disposed in a platform having various shapes, such as a chip shape and a disc shape.

The microfluidic device includes a chamber that accommodates a fluid, a channel through which the fluid flows, and a valve that controls the flow of the fluid. The chamber, the channel, and the valve are disposed within the platform in various combinations.

Arranging the microfluidic structure in the platform having a chip shape, so as to perform a test including a biochemical reaction on a small chip, is referred to as a bio chip. In particular, a device that is manufactured to perform treatment and manipulation in several steps in one chip, is referred to as a lab-on-a chip.

A driving pressure is required to transfer the fluid within the microfluidic structure. A capillary pressure or pressure generated by a separate pump is used as the driving pressure. Centrifugal force-based microfluidic devices that perform a series of works by disposing the microfluidic structure in the platform having a disc shape and by moving a fluid using centrifugal force, have been recently suggested. These microfluidic devices are referred to as a lab compact disc (CD) or lab-on-a CD.

A sample injected into the centrifugal force-based microfluidic device is moved by the centrifugal force to be far from a center of rotation of the microfluidic device.

The sample is injected into the microfluidic device through a sample injection hole formed in the microfluidic device using an injection means, such as a pipette or syringe. While the sample is injected, the sample may be stained around the sample injection hole.

As a result, when the microfluidic device stained with the sample is mounted on a sample testing device and is rotated, a biological sample stained around the sample injection hole may contaminate the surface of the microfluidic device. Consequently, a small amount of sample may contaminate components in the sample testing device due to rotation. If the sample is stained on a light source, an error may occur in a resultant value of the microfluidic device.

Also, when a sample infected with pathogenic bacteria is injected into the microfluidic device, the sample that remains in the surface of the microfluidic device may cause infection of other people.

### SUMMARY

One or more exemplary embodiments provide a microfluidic device having a structure in which a sample is capable of being prevented from being stained on a surface of the microfluidic device while the sample is injected into the microfluidic device.

One or more exemplary embodiments also provide a microfluidic device having an improved structure in which a sample stained on a surface of the microfluidic device is capable of being prevented from causing contamination of components within a sample testing device.

In accordance with an aspect of an exemplary embodiment, there is provided a microfluidic device including: a platform including: a sample injection hole, at least one chamber configured to accommodate a sample introduced through the sample injection hole, at least one channel connected to the at least one chamber; and a cover disposed over the sample injection hole, wherein a gap is disposed between the sample injection hole and the cover.

The platform may be rotatably disposed about a rotation axis, and the gap includes a recessed portion formed in the platform recessed downwardly in a direction of the rotation axis, and the sample injection hole may be disposed within the recessed portion.

An opening connected with the recessed portion May be formed in the platform, and the microfluidic device may further include a remaining sample accommodation portion disposed beneath the opening, and configured to receive an amount of overflow sample material through the opening.

The sample accommodated in the recessed portion may be moved to the remaining sample accommodation portion via the opening due to centrifugal force.

The platform may include a bump protruding upwardly from the top surface of the platform, and the bump is spaced apart from the recessed portion and the opening is disposed between the bump and the recessed portion.

The bump may be disposed along a circumference of the opening.

The cover may be adhered onto the platform.

The cover may include a cutting line positioned to correspond to the sample injection hole.

The cover may include a sample injection hole mark corresponding to a position of the sample injection hole.

The at least one chamber may include a sample chamber configured to accommodate the sample introduced through the sample injection hole, and the sample chamber includes at least one ledge positioned near the sample injection hole to limit a degree of insertion of a sample injection device introduced through the sample injection hole.

The at least one ledge may be disposed at an inner wall of the sample chamber and protrudes into the sample chamber.

The at least one ledge includes a first ledge and a second ledge, the second ledge protruding into the sample chamber to a degree different from a protruding degree of the first ledge and the first and second ledges are disposed at different heights in the sample chamber.

At least part of the platform may be hydrophilic.

The at least one chamber may include a sample chamber configured to accommodate the sample introduced through the sample injection hole, and the sample chamber is hydrophilic.

An absorption member is disposed in the gap to absorb the sample remaining in the gap, and the absorption member may include a porous material.

In accordance with an aspect of another exemplary embodiment, there is provided a microfluidic device including: a platform having a rotation axis, the platform including: a sample injection hole, at least one chamber configured to accommodate a sample introduced through the sample injection hole, at least one channel connected to the at least one chamber, and a recessed portion disposed downwardly in a direction of the rotation axis; and an absorption member disposed in the recessed portion to absorb sample material that overflows from the sample injection hole.

The platform includes an opening disposed adjacent to the sample injection hole in a radial direction away from a center part of the platform, and the microfluidic device may further include a remaining sample accommodation portion connected to the opening.

The platform may include a bump protruding upwardly from a top surface of the platform, and the bump may be disposed along a circumference of the opening in a radial direction away from the rotation axis.

The recessed portion and the bump surround the opening discontinuously.

The absorption member is disposed on the recessed portion so as to cover the sample injection hole.

A sample injection device for injecting the sample through the sample injection hole passes through the absorption member and is inserted into the sample injection hole.

The absorption member may include a hydrophilic material.

The microfluidic device may further include a cover disposed on the platform to cover the absorption member.

In accordance with an aspect of another exemplary embodiment, there is provided a microfluidic device including: a platform including: a sample injection hole; and a sample chamber configured to accommodate a sample injected through the sample injection hole and connected with the sample injection hole, wherein at least part of the platform is hydrophilic.

Inner walls of the sample chamber are hydrophilic.

In accordance with an aspect of another exemplary embodiment, there is provided a microfluidic device including: a platform comprising a sample injection hole abutting a convex surface; a chamber formed in the platform configured to accommodate a sample introduced through the sample injection hole; a recessed portion formed in the platform, wherein the sample injection hole is formed in the recessed portion, and the platform.

The microfluidic device further includes a remaining sample accommodating portion disposed beneath the opening and configured to receive an amount of overflow sample material through the opening.

The at least one chamber includes a sample chamber configured to accommodate the sample introduced through the sample injection hole, and the sample chamber including at least one ledge positioned near the sample injection hole to limit a degree of insertion of a sample injection device introduced through the sample injection hole.

### BRIEF DESCRIPTION OF THE DRAWINGS

These and/or other aspects of exemplary embodiments will become apparent and more readily appreciated from the following description of the embodiments, taken in conjunction with the accompanying drawings of which:

FIG. 1 is a perspective view of a microfluidic device in accordance with an exemplary embodiment;

FIG. 2 is a plan view of the entire structure of the microfluidic device in accordance with an exemplary embodiment;

FIG. 3 is a cross-sectional view of a sample injection hole of the microfluidic device in accordance with an exemplary embodiment;

FIG. 4 is a perspective view of a microfluidic device in accordance with another embodiment;

FIG. 5 is a cross-sectional view of a sample injection hole of the microfluidic device in accordance with another embodiment;

FIG. 6 is a view of a state in which a cover of the microfluidic device in accordance with another exemplary embodiment is disposed to cover part of a platform;

FIG. 7 is a view of a state in which a cutting line is formed in the cover of the microfluidic device in accordance with another exemplary embodiment;

FIG. 8 is a view of a state in which a sign of the sample injection hole is disposed in the cover of the microfluidic device in accordance with another exemplary embodiment;

FIG. 9 is a cross-sectional view of part of a microfluidic device in accordance with still another exemplary embodiment;

FIG. 10 is a plan view of the entire structure of the microfluidic device in accordance with still another exemplary embodiment;

FIG. 11 is a view of a configuration of a sample testing device that uses the microfluidic device in accordance with an exemplary embodiment;

FIG. 12 is a perspective view of a microfluidic device in accordance with another exemplary embodiment;

FIG. 13 is an exploded view of a fluid analysis cartridge and a mounting member of a fluid analysis device to which the fluid analysis cartridge is coupled, of the microfluidic device in accordance with another exemplary embodiment;

FIG. 14 is a view of a state in which the fluid analysis cartridge is coupled to the mounting member of the fluid analysis device to which the fluid analysis cartridge is coupled, of the microfluidic device in accordance with another exemplary embodiment;

FIG. 15 is a view of the fluid analysis cartridge of the microfluidic device in accordance with another exemplary embodiment;

FIG. 16 is an exploded view of a testing unit of the fluid analysis cartridge of the microfluidic device in accordance with another exemplary embodiment; and

FIG. 17 is a cross-sectional view of the testing unit of the fluid analysis cartridge taken along direction AA′ of FIG. 15.

### DETAILED DESCRIPTION

Reference will now be made in detail to exemplary embodiments, examples of which are illustrated in the accompanying drawings, wherein like reference numerals refer to like elements throughout. Relative terms used herein, such as a “front end,” a “rear end,” an “upper portion,” a “lower portion,” a “top end,” and a “bottom end,” are shown by example in the drawings. The shape and position of each element are not limited by the terms.

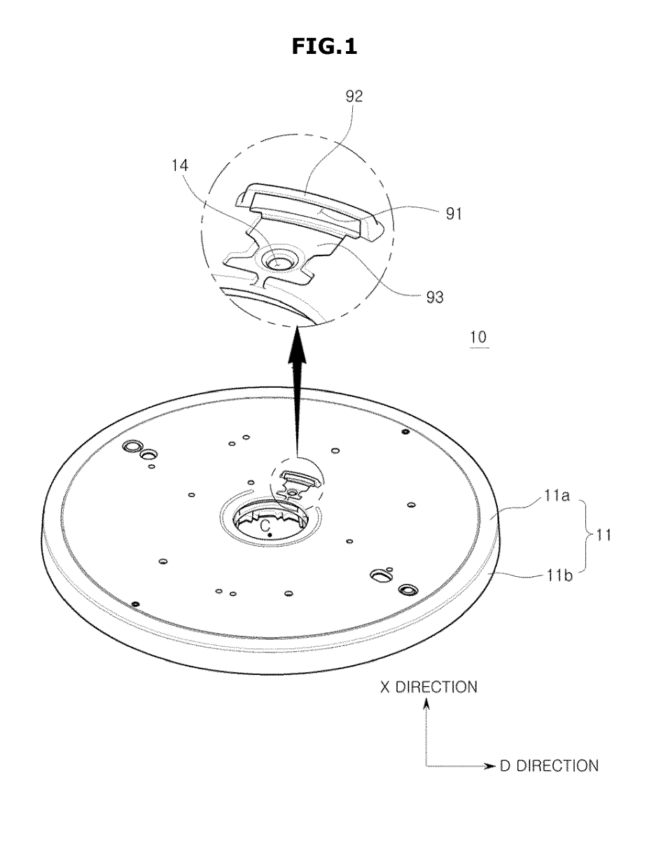

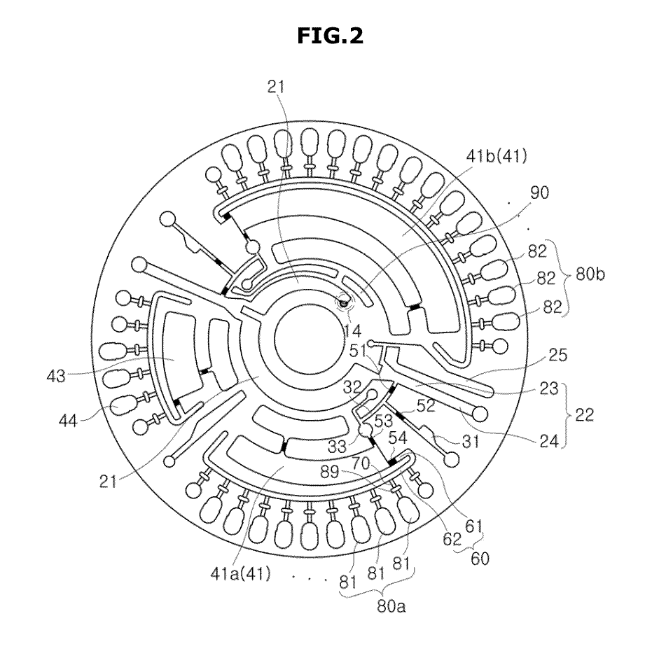

FIG. 1 is a perspective view of a microfluidic device in accordance with an exemplary embodiment, and FIG. 2 is a plan view of the entire structure of the microfluidic device in accordance with an exemplary embodiment. Hereinafter, a remaining sample is a sample that remains in an outside of a sample injection hole 14 irrespective of the cause. Also, a fluid may be used to include the sample.

As illustrated in FIGS. 1 and 2, a microfluidic device 10 includes a disc-shaped platform 11, at least one chamber which is partitioned within the platform 11 and in which the fluid may be accommodated, and at least one channel which is partitioned within the platform 11 and in which the fluid may flow. At least one channel may connect a plurality of chambers.

The platform 11 may be rotatable. In detail, the platform 11 may be rotated when a center C of the platform 11 is used as an axis. Movement of the sample, centrifugal separation, and mixing may be performed in at least one chamber and channel by an action of centrifugal force caused by rotation of the platform 11.

The sample injection hole 14 is provided in the platform 11. The sample is introduced through the sample injection hole 14 and accommodated in a sample chamber 21 disposed in the platform 11.

The platform 11 is formed of a plastic material, such as acryl or polydimethylsiloxane (PDMS), which may be easily formed and of which a surface is biologically inactive. However, the platform 11 is not limited thereto, and it will be sufficient that the platform 11 is formed of a material having chemical and biological stability, optical transparency, and mechanical machinability.

The platform 11 may be formed of several-layered plates. By forming engraved structures that correspond to a chamber or channel at a surface on which plates contact each other and by bonding the engraved structures to each other, a space and a path may be provided within the platform 11.

For example, the platform 11 may have a structure including a first substrate 11a and a second substrate 11b attached to the first substrate 11a. Alternatively, the platform 11 may have a structure in which a partitioning plate (not shown) for a chamber in which the fluid may be accommodated and a channel through which the fluid may flow, is disposed between the first substrate 11a and the second substrate 11b. The shape of the platform 11 is not limited to the above example. The first substrate 11a and the second substrate 11b may be formed of thermoplastic resins.

Bonding of the first substrate 11a and the second substrate 11b can be performed using various methods, such as adhesion using an adhesive or a double-sided adhesive tape, ultrasonic fusion, and laser fusion.

The microfluidic device 10 further includes a remaining sample accommodation portion 90 to prevent an outer surface of the platform 11 from being contaminated by a sample that remains around the sample injection hole 14. A bump 92 prevents the remaining sample from flowing outwardly in a radial direction D of the platform 11, and a recessed portion 93 guides the remaining sample around the sample injection hole 14 toward the remaining sample accommodation portion 90.

The recessed portion 93 formed on the platform 11 is recessed downwardly into the platform surface in a direction X parallel to a rotation axis of the platform 11. The recessed portion 93 may be formed on the first substrate 11a of the platform 11. The sample injection hole 14 is provided within the recessed portion 93. That is, the recessed portion 93 surrounds the sample injection hole 14 to prevent the remaining sample from being scattered toward an outside of the sample injection hole 14.

An opening 91 formed in the platform 11 allows the remaining sample being moved outwardly in the radial direction D of the platform 11 by rotation of the platform 11 to be introduced into the remaining sample accommodation portion 90 through the opening 91. The opening 91 may be formed in the first substrate 11a of the platform 11. That is, the remaining sample accommodation portion 90 accommodates the remaining sample introduced into the platform 11 through the opening 91.

The opening 91 is disposed adjacent to the recessed portion 93.

The bump 92 formed on the platform 11 protrudes upwardly in the direction X from a surface of the platform. The bump 92 is formed on the first substrate 11a of the platform 11. The bump 92 is configured to prevent the remaining sample that is moved outwardly in the radial direction D of the platform 11 by rotation of the platform 11 from being distributed away from the opening 91. In other words, bump 92 prevents the remaining sample from continuously moving outwardly in the radial direction D of the platform 11 due to rotational centrifugal force.

The bump 92 may be disposed to be spaced apart from the recessed portion 93. The bump 92 may be disposed to be spaced apart from the recessed portion 93 in a state in which the opening 91 is disposed between the bump 92 and the recessed portion 93. That is, the bump 92 may be disposed outwardly in the radial direction D of the platform 11, and centered about the opening 91, and the recessed portion 93 may be disposed inwardly in the radial direction D of the platform 11, and centering about the opening 91 and spaced apart from the bump 92.

The bump 92 may be disposed along a circumference of the opening 91. In detail, the bump 92 may be disposed along the perimeter circumference of the opening 91 outwardly in the radial direction D of the platform 11. In comparison to the opening 91, the bump 92 is further away from the center C.

The bump 92 may have a curvature. In detail, the bump 92 may have a shape that is bent toward a center C of the platform 11. The bump 92 may have a concave shape or form a cavity facing towards opening 91.

The recessed portion 93 and the bump 92 may discontinuously surround the opening 91.

A width of the recessed portion 93 may be smaller than that of the opening 91. In detail, the width of the recessed portion 93 as measured along a circumferential direction of the platform 11 may be smaller than that of the opening 91 as measured along the circumferential direction of the platform 11. However, the relationship between the width of the recessed portion 93 and the width of the opening 91 is not limited thereto.

The remaining sample accommodation portion 90 is disposed to be spaced apart from the sample chamber 21 and the channel connected to the sample chamber 21. Separation is provided so that the remaining sample is not mixed with the sample in the sample chamber 21.

The remaining sample accommodation portion 90 may communicate with the opening 91. The sample accommodation portion is disposed beneath the opening to receive the remaining sample. The remaining sample accommodation portion 90 that is a space in which the remaining sample introduced through the opening 91 is accommodated, is formed to be engraved in the second substrate 11b.

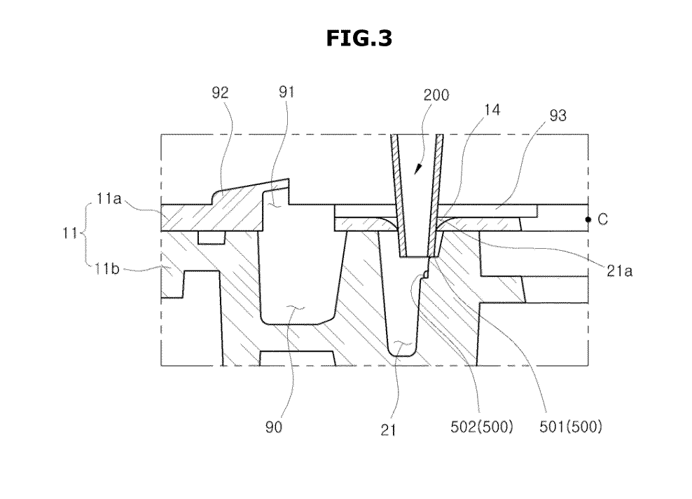

Hereinafter, an operation of injecting the sample into the microfluidic device 10 will be sequentially described. A fluid sample, such as blood, is injected into the microfluidic device 10 using a sample injection device (see 200 of FIG. 3). The sample injection device 200 includes a pipette and a spoid.

The sample injection device 200 in which the sample is accommodated is inserted into the sample injection hole 14, and the sample accommodated in the sample injection device 200 is ejected and injected into the sample chamber 21. After injection of the sample into the sample chamber 21 is completed, the sample injection device 200 is separated from the sample injection hole 14. While the sample injection device 200 is separated from the sample injection hole 14, a portion of the sample material, or the remaining sample, may stain the area around the sample injection hole 14. Alternatively, the sample injected into the sample injection hole 14 may overflow and may stain the area around the sample injection hole 14.

As a result, when the microfluidic device 10 is rotated, the remaining sample which stained the area around the sample injection hole 14 is moved to the opening 91 along an edge of the recessed portion 93 due to the centrifugal force. The remaining sample that is moved to the opening 91 is introduced into the remaining sample accommodation portion 90 formed in the platform 11 through the opening 91. Thus, the remaining sample on the outer surface of the microfluidic device 10 is guided toward a certain position, and the remaining sample is prevented from being scattered in an arbitrary position.

Hereinafter, microfluidic structures to be disposed within the platform 11 to test the sample will be described.

The sample may be formed by mixing the fluid with a material having a shape of particles with higher density than that of the fluid. For example, the sample may include a biological sample, such as blood, saliva, or urine.

The at least one chamber includes the sample chamber 21. The sample chamber 21 is disposed inwardly in the radial direction D of the platform 11 relative to the opening 91 and bump 92. The sample chamber 21 is partitioned so that a predetermined amount of sample may be accommodated in the sample chamber 21, and the sample injection hole 14 through which the sample is injected into the sample chamber 21, is formed in a top surface of the sample chamber 21.

The at least one chamber further includes a sample separation chamber 22. The sample separation chamber 22 may be disposed outward from the sample chamber 21 in the radial direction D of the platform 11 and may centrifugally-separate the sample using rotation of the platform 11.

The at least one chamber further includes an overflow chamber 25. The overflow chamber 25 is disposed at one side of the sample separation chamber 22. When an excessive amount of the sample is injected into the sample chamber 21, the overflow chamber 25 accommodates excess remaining sample when a predetermined amount of the sample required for a test in the sample separation chamber 22.

When the sample is blood, in the sample separation chamber 22, a blood corpuscle having a large weight is moved towards an outward part of the chamber 22 due to the centrifugal force, and serum having a relatively small weight is placed at an upper portion of the blood corpuscle and is separated from the blood.

The sample separation chamber 22 may include a supernatant collecting portion 23 having a shape of a channel that extends from the sample chamber 21 outwardly in the radial direction D of the platform 11, and a sediment collecting portion 24 that is disposed at a distal outward end of the supernatant collecting portion 23 and provides a space in which a sediment having a large specific gravity may be accommodated.

A guide channel 32 that guides the supernatant separated from the sample separation chamber 22 toward a dilution chamber 41 in which a dilution buffer is accommodated, is formed at one side of the sample separation chamber 22.

The at least one chamber further includes a temporary storage chamber 33 and a supernatant removing chamber 31. The temporary storage chamber 33 and the supernatant removing chamber 31 are provided in the midway of the guide channel 32. The temporary storage chamber 33 is formed at an inlet of the dilution chamber 41 and temporarily stores the supernatant introduced into the dilution chamber 41. The supernatant removing chamber 31 accommodates the supernatant that remains in the guide channel 32 after the supernatant is accommodated in the temporary storage chamber 33 and removes the supernatant from the guide channel 32.

The at least one chamber further includes at least one dilution chamber 41. The at least one dilution chamber 41 may be provided in plural so that different amounts of dilution buffers are stored in the plurality of dilution chambers 41, and volumes of the plurality of dilution chambers 41 are different from each other according to the volume of a required dilution buffer. The dilution chamber 41 is partitioned off into two or more parts, and the microfluidic device 10 according to the present exemplary embodiment includes a first dilution chamber 41a and a second dilution chamber 41b in which dilution buffers having different volumes are accommodated so that dilution ratios can be made different from each other.

A dilution chamber 43 to which the sample is not supplied from the sample separation chamber 22, is provided. The dilution chamber 43 stores the dilution buffer to obtain a standard value while a reaction is detected. Chambers 44 for obtaining detected standard values that are empty or filled with distilled water are provided at an outer portion of the dilution chamber 43 to which the sample is not supplied.

A distribution channel 60 may be connected to an outlet of the dilution chamber 41. The distribution channel 60 includes a first section 61 that is connected to the outlet of the dilution chamber 41 and a second section 62 that extends from the first section 61 along a circumferential direction of the platform 11. One end of the first section 61 is connected to the outlet of the dilution chamber 41, and the other end of the first section 61 may be connected to the second section 62. An end of the second section 62 is connected to an exhaust port (not shown). The exhaust port is disposed in a position in which the sample may not leak when the sample is transported from the dilution chamber 41 to the distribution channel 60 using the centrifugal force. A fluid resistance is uniform from a front end of the distribution channel 60 connected to the outlet of the dilution chamber 41 to a rear end of the distribution channel 60 connected to the exhaust port, i.e., over all sections including the first section 61 and the second section 62. In order to make the fluid resistance uniform, a cross-sectional area of the distribution channel 60 is uniform in all sections. Thus, a resistance against movement of the fluid that additionally occurs during a sample distribution procedure is excluded as much as possible so that the sample may be rapidly and effectively distributed.

Reaction chamber groups 80a and 80b that correspond to the first dilution chamber 41a and the second dilution chamber 41b are disposed at outsides of the first dilution chamber 41a and the second dilution chamber 41b in the radial direction D of the platform 11. A first reaction chamber group 80a corresponding to the first dilution chamber 41a is disposed at the outside of the first dilution chamber 41a in the radial direction D of the platform 11. A second reaction chamber group 80b corresponding to the second dilution chamber 41b is disposed at the outside of the second dilution chamber 41b in the radial direction D of the platform 11.

Each of the reaction chamber groups 80a and 80b includes at least one reaction chamber 81 and 82, and the reaction chambers 81 and 82 are connected to the corresponding dilution chamber 41 through the distribution channel 60 that distributes the dilution buffer. Each of the reaction chamber groups 80a and 80b may include one reaction chamber in the simplest manner.

The reaction chambers 81 and 82 may be closed type chambers. The closed type means a shape in which no vent for ventilating is formed in each of the reaction chambers 81 and 82. A sample dilution buffer distributed through the distribution channel 60 and reagents having various types or concentrations that cause optically-detectable reactions may be previously injected into the plurality of reaction chambers 81 and 82. Examples of the optically-detectable reactions may include fluorescence generation or a change in optical density. However, usages of the reaction chambers 81 and 82 are not limited to the above.

Reagents that are suitable for reactions with the sample dilution buffers having the same dilution ratio are respectively stored in the plurality of reaction chambers 81 and 82 that belong to the same reaction chamber groups 80a and 80b.

For example, reagents that react with the sample dilution buffer on a condition that a dilution ratio of the dilution buffer/serum is 100, such as triglycerides (TRIG), total cholesterol (Chol), glucose (GLU), and urea nitrogen (BUN), are stored in the first reaction chamber group 80a. Reagents that react with the sample dilution buffer on a condition that a dilution ratio of the dilution buffer/serum is 20, such as direct bilirubin (DBIL), total bilirubin (TBIL), and gamma glutamyl transferase (GGT), are stored in the second reaction chamber group 80b.

That is, since the sample dilution buffer having a different dilution ratio from that of the first reaction chamber group 80a is supplied to the plurality of reaction chambers 81 and 82 that belong to the second reaction chamber group 80b, from the second dilution chamber 41b corresponding to the second reaction chamber group 80b, reagents suitable for the sample having the corresponding dilution ratio are respectively stored in the reaction chambers 81 and 82 of the respective reaction chamber groups 80a and 80b.

The reaction chambers 81 and 82 are formed to have the same capacity. However, embodiments are not limited thereto, and capacities of the reaction chambers 81 and 82 may be different from each other when sample dilution buffers or reagents having different capacities are required according to a testing item.

Also, the plurality of reaction chambers 81 and 82 may be chambers having vents and injection holes.

Each of the plurality of reaction chambers 81 and 82 are connected to the second section 62 of the distribution channel 60 through an inlet channel 70. The inlet channel 70 is formed to be diverged from the distribution channel 60. In this case, the inlet channel 70 is connected to the distribution channel 60 in a T shape. The inlet channel 70 may extend in the radial direction D of the platform 11.

Valves 51, 52, 53, and 54 may be disposed in at least one channel that connects the at least one chamber. The valves 51, 52, 53, and 54 include a first valve 51 that is disposed in the midway of the guide channel 32 and opens/closes an outlet of the sample separation chamber 22, a second valve 52 that is disposed in the midway of the guide channel 32 and opens/closes the supernatant removing chamber 31, a third valve 53 that is disposed between the temporary storage chamber 33 and the dilution chamber 41, and a fourth valve 54 that is disposed at an outlet of the dilution chamber 41 and opens/closes the distribution channel 60.

Each of the valves 51, 52, 53, and 54 may be various types of valves, such as a valve that is manually opened when a predetermined pressure is applied to the valve, such as a capillary valve, and a valve that actively operates by receiving power or energy from the outside in response to an operating signal. The microfluidic device 10 according to an exemplary embodiment adopts a phase change valve that absorbs energy from the outside and operates.

Each of the valves 51, 52, 53, and 54 is disposed in the above-described position between the first substrate 11a and the second substrate 11b that constitute the platform 11 in a three-dimensional or planar shape, blocks the flow of the sample, is molten at a high temperature, is move to an adjacent clearance, and opens channels.

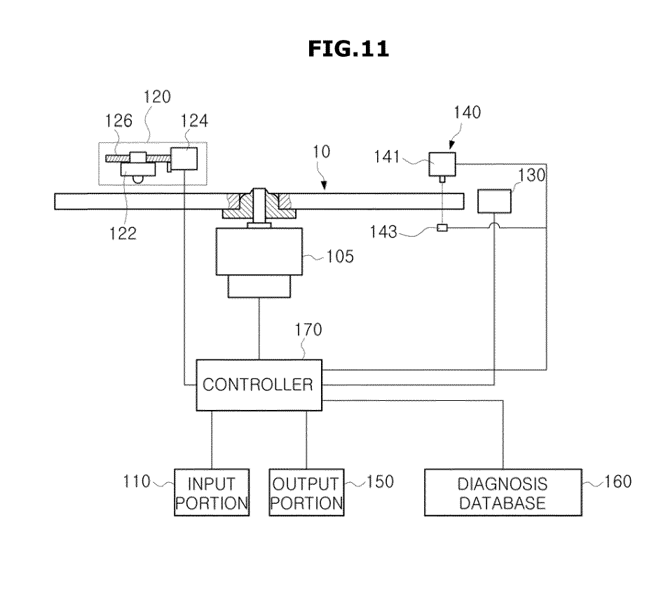

In order to heat the valves 51, 52, 53, and 54, an external energy source (see 122 of FIG. 11) that emits light may be movably disposed outside the platform 11, and the external energy source 122 may radiate light in a region in which the valves 51, 52, 53, and 54 are placed.

Thus, the external energy source 122 may be moved to upper portions of the valves 51, 52, 53, and 54 that need to be opened according to a stage of testing being performed using the microfluidic device 10. The energy source 122 may radiate light downwardly and open the corresponding valves 51, 52, 53, and 54.

The valves 51, 52, 53, and 54 may be formed of a phase change material and heating particles dispersed into the phase change material.

The heating particles may have sizes at which they may be freely moved within a channel having a width of several hundred to several thousand micrometers (μm). If light, for example, laser is radiated onto the heating particles. The heating particles have characteristics that the temperature of the heating particles rises rapidly due to energy of the light and the heating particles are heated. In order to have the characteristics, the heating particles may have a structure including a core including metal components and a shell having a hydrophobic property. For example, the heating particles may have a structure including a core formed of iron (Fe) and a shell including a plurality of surfactants that are coupled to Fe and surround Fe. A material that is available in the market while being dispersed into a carrier oil may be adopted as the heating particles.

The phase change material may be wax. If light energy absorbed by the heating particles is transferred to the surroundings in the form of thermal energy, the wax is molten and has liquidity. Thus, the valves 51, 52, 53, and 54 are collapsed, and flow paths thereof are opened. The wax may have an appropriate melting point. If the melting point is too high, time until the wax is molten after light starts being radiated, is long so that precise control of an opening time becomes difficult. If the melting point is too low, the wax may be partially molten in a state in which light is not radiated, and a fluid may leak. For example, paraffin wax, microcrystalline wax, synthetic wax, or natural wax may be adopted as the wax.

The phase change material may also be gel or thermoplastic resin. The gel may be formed of polyacrylamide, polyacrylates, polymethacrylates, or polyvinylamides. Also, COC, PMMA, PC, PS, POM, PFA, PVC, PP, PET, PEEK, PA, PSU, or PVDF may be adopted as the thermoplastic resin.

Also, a bar code (not shown) may be disposed on a side surface of the platform 11. Various information, such as a manufactured date and an expiration date of the microfluidic device 10, may be stored in the bar code as needed.

The bar code may be a one-dimensional bar code and may be a bar code having various shapes, for example, a matrix code, such as a two-dimensional bar code, so as to store a large amount of information.

The bar code may be replaced with a hologram, a radio frequency identification (RFID) tag, or a memory chip in which information may be stored. When a storage medium for reading and writing information, for example, a memory chip, is configured instead of the bar code, information regarding a sample testing result, information regarding a patient, information regarding blood gathering and testing date and time, and information regarding whether to perform a test, in addition to identification information may be stored in the memory chip.

Since the plurality of reaction chambers 81 and 82 are disposed adjacent to each other, cross contamination between the reaction chambers 81 and 82 in which a material in one of the reaction chambers 81 and 82 is introduced into the other one of the reaction chambers 81 and 82, may occur. If cross contamination occurs, it is difficult to attain an accurate sample testing result.

Thus, the microfluidic device 10 may further include a delay structure 89 for reducing cross contamination between the reaction chambers 81 and 82.

FIG. 3 is a cross-sectional view of a sample injection hole of the microfluidic device in accordance with an exemplary embodiment. Reference numbers used in FIG. 3 are consistent with those used to describe features in FIGS. 1 and 2.

As illustrated in FIG. 3, at least one ledge 500 may be disposed in the sample chamber 21. The at least one ledge 500 may be disposed in the sample chamber 21 in order to adjust a degree of insertion of the sample injection device 200 inserted into the sample injection hole 14.

When the sample injection device 200 is deeply inserted into the sample injection hole 14, for example, the sample injection device may come into contact with a bottom surface of the sample chamber 21. As a result, the sample discharged from the sample injection device 200 may flow backward through the sample injection hole 14 and may contaminate the surroundings of the sample injection hole 14. The at least one ledge 500 is disposed on the sample chamber 21 to prevent the sample injection device 200 from being deeply inserted into the sample injection hole 14. The downward movement of one edge of the sample injection device 200 inserted into the sample injection hole 14 may be limited by the ledge.

A protrusion 21a may be provided over the sample chamber 21 so as to form an inwardly shaped taper around the sample injecting home 14 into the chamber 21. The protrusion 21a serves to guide the sample injection device 200 inserted into the sample injection hole 14 toward an inside of the sample chamber 21. The protrusion 21a may include a shape of a convex curved surface directed inwardly towards the chamber.

The at least one ledge 500 may be formed at the inner walls of the sample chamber 21 so as to correspond in position to the protrusion 21a. In detail, the at least one ledge 500 may be formed at the inner walls of the sample chamber 21 so as to protrude toward an inside of the sample chamber 21. The at least one ledge 500 may be formed at the inner walls of the sample chamber 21, disposed closer to the center C, so as to protrude outwardly in the radial direction D of the platform 11, away from center C.

Degrees at which the at least one ledge 500 protrudes outwardly in the radial direction D of the platform 11, may be different from each other. This is to effectively cope with the sample injection device 200 having different diameters.

The at least one ledge 500 may be formed at the inner walls of the sample chamber 21 so as to be spaced apart from the bottom surface of the sample chamber 21.

The at least one ledge 500 may be disposed at different heights in the chamber 21, the axial direction X of the platform 11. For example, the at least one ledge 500 may include a first ledge 501 placed at an upstream side along the axial direction X of the platform 11 and a second ledge 502 placed at a downstream side along the axial direction X of the platform 11. A degree at which the first ledge 501 protrudes outwardly in the radial direction D of the platform 11, may be smaller than a degree at which the second ledge 502 protrudes outwardly in the radial direction D of the platform 11. That is, the second ledge 502 may further protrude from the wall into the interior cavity of the sample chamber 21 than the first ledge 501. It is difficult to deeply insert the sample injection device 200 having a large diameter into the sample injection hole 14 because the insertion of the sample injection device 200 having the large diameter will be limited by the first ledge 501. The sample injection device 200 having a small diameter will be limited by at least one of the first ledge 501 and the second ledge 502.

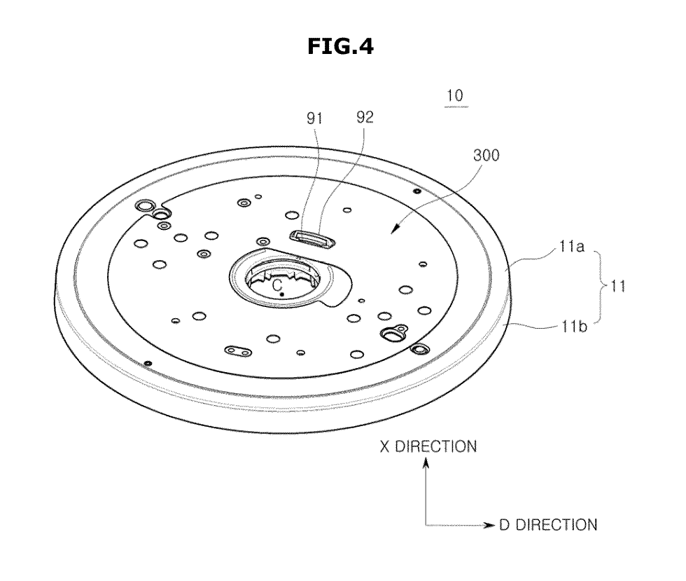

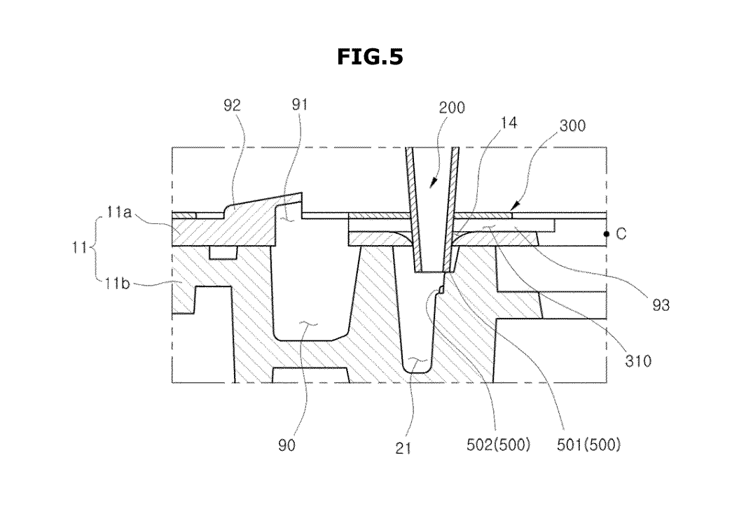

FIG. 4 is a perspective view of a microfluidic device in accordance with another embodiment, and FIG. 5 is a cross-sectional view of a sample injection hole of the microfluidic device in accordance with another exemplary embodiment. Unillustrated reference numerals refer to FIGS. 1 through 3. A redundant description of reference numerals used with FIGS. 1 through 3 may be omitted.

The microfluidic device 10 includes a disc-shaped platform 11 having a sample injection hole 14, at least one chamber disposed in the platform 11 so as to accommodate the fluid, and at least one channel through which the fluid accommodated in the at least one chamber may flow.

The microfluidic device 10 may further include a cover 300 disposed over the sample injection hole 14.

A gap 310 may be formed between the sample injection hole 14 and the cover 300. The sample injection hole 14 may be disposed in a recessed portion 93 that constitutes a step formed into a surface of the platform 11. The cover 300 may be disposed over the sample injection hole 14 so as to form the gap 310 between the cover 300 and the sample injection hole 14 in the direction X.

The size of the gap 310 may be determined by coupling of the recessed portion 93 and the cover 300.

The cover 300 may be coupled to an outer surface of the platform 11. In detail, the cover 300 may be coupled onto a first substrate 11a so as to cover the sample injection hole 14.

Also, the cover 300 may be coupled onto the first substrate 11a so as to leave open the opening 91.

Also, the cover 300 may be coupled onto the first substrate 11a so as to not cover a bump 92, i.e., so that the bump 92 may be exposed to the outside.

The cover 300 may be disposed over the sample injection hole 14, and embodiments are not limited to the above example.

The sample that flows backward through the sample injection hole 14 remains in the gap 310 formed between the sample injection hole 14 and the cover 300 due to capillary force. The sample that remains in the gap 310 or is accommodated in the gap 310 is moved to the remaining sample accommodation portion 90 due to centrifugal force formed when the microfluidic device 10 is rotated. In this way, the cover 300 is disposed over the sample injection hole 14 so that a level of the sample that remains in the gap 310 may be maintained to be lower than that of the bump 92, and as such, the remaining sample may be prevented from overpassing the bump 92 and being scattered.

The cover 300 may include a material having adhesion. That is, the cover 300 may be adhered onto the platform 11. In detail, the cover 300 may be adhered onto the first substrate 11a so as to form the gap 310 between the cover 300 and the sample injection hole 14.

At least one ledge 500 may be disposed in a sample chamber 21 so as to control an insertion amount of a sample injection device 200 inserted into the sample injection hole 14.

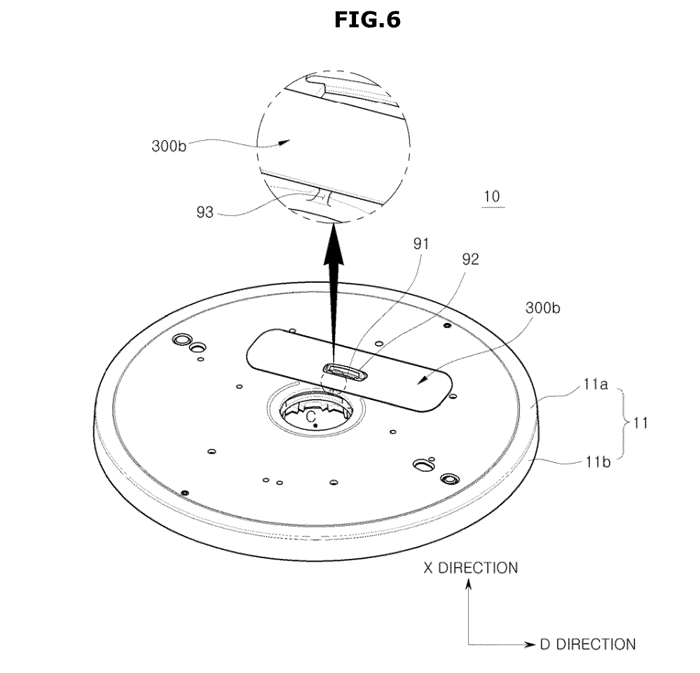

FIG. 6 is a view of a state in which a cover of the microfluidic device in accordance with another exemplary embodiment is disposed to cover part of a platform. Reference numbers used in FIG. 6 are consistent with those used to describe features in FIGS. 1 through 5.

As illustrated in FIG. 6, the cover 300b may be disposed to cover part of the platform 11. The cover 300b may be disposed to cover more of the first substrate 11a than shown in other embodiments. That is, the cover 300b may be disposed on the first substrate 11a so as to cover the sample injection hole 14, and the size of the cover 300b may be freely deformed.

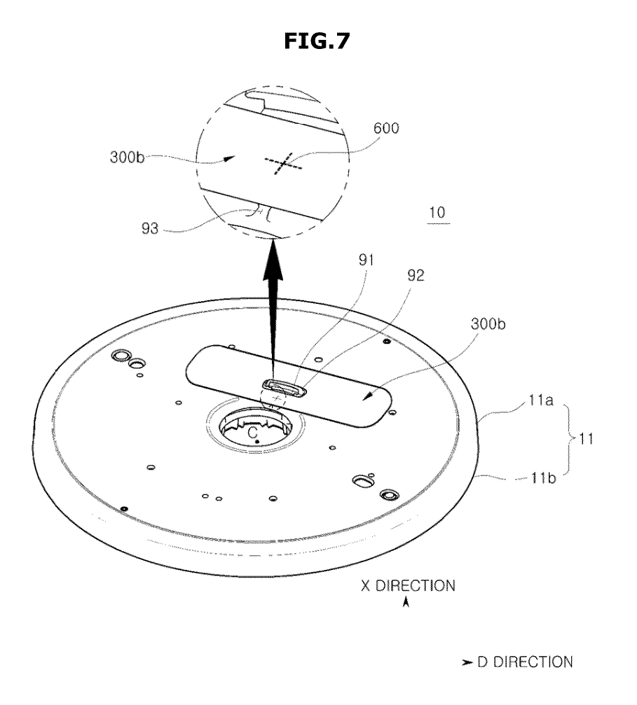

FIG. 7 is a view of a state in which a cutting line is formed in the cover of the microfluidic device in accordance with another exemplary embodiment. Reference numbers used in FIG. 7 are consistent with those used to describe features in FIGS. 1 through 5.

As illustrated in FIG. 7, the cover 300b may include a cutting line 600 formed to correspond to a position of the sample injection hole 14 disposed beneath the cover. The cutting line 600 may include a cut. The cutting line 600 may be formed in a cross shape but is not limited thereto. The cutting line 600 may include at least one of shape and color so as to improve visibility of a position of the sample injection hole 14.

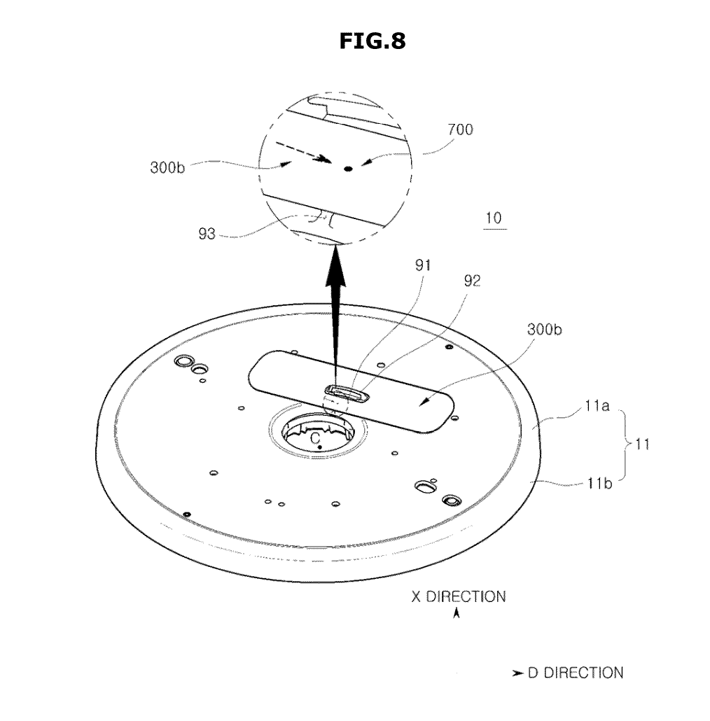

FIG. 8 is a view of a state in which a mark of the sample injection hole is disposed in the cover of the microfluidic device in accordance with another exemplary embodiment. Reference numbers correspond to those structures describes in FIGS. 1-7.

As illustrated in FIG. 8, the cover 300b may include a sample injection hole mark 700 formed to display the position of the sample injection hole 14. Visibility of the position of the sample injection hole 14 may be improved through the sample injection hole mark 700. The sample injection hole mark 700 may display the position of the sample injection hole 14 using various methods, such as arrows, characters, colors, and figures.

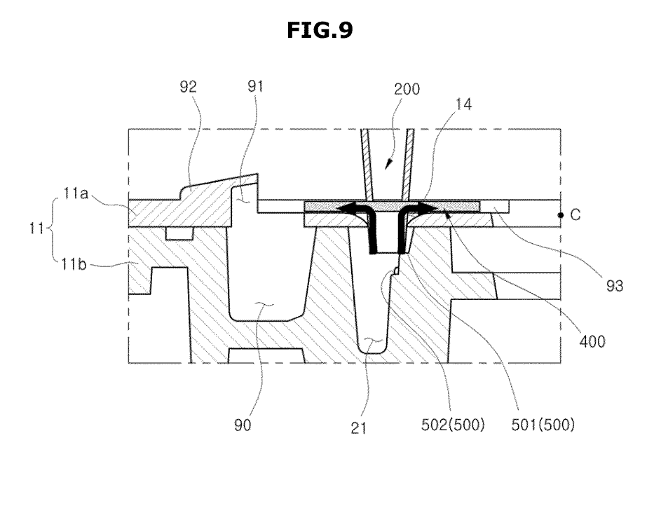

FIG. 9 is a cross-sectional view of part of a microfluidic device in accordance with still another exemplary embodiment. Reference numbers correspond to those structures describes in FIGS. 1-8.

The microfluidic device 10 includes a rotatably disposed platform 11 that has a sample injection hole 14, at least one chamber disposed in the platform 11 so as to accommodate the sample introduced through the sample injection hole 14, and at least one channel through which the fluid accommodated in the at least one chamber may flow.

The microfluidic device 10 may further include an absorption member 400 disposed in a recessed portion 93 so as to absorb the sample that overflows from the sample injection hole 14.

The absorption member 400 may be disposed on the recessed portion 93 so as to cover the sample injection hole 14.

A sample injection device 200 that injects the sample into the sample injection hole 14 may be inserted into the sample injection hole 14 by passing through the absorption member 400.

The absorption member 400 may include a hydrophilic material.

Also, the absorption member 400 may include a porous material.

The absorption member 400 may include at least one of sulfone-based hydrophilic polymer, cellulose-based hydrophilic polymer, and acryl-based hydrophilic polymer. The sulfone-based polymer may include polysulfone. The cellulose-based polymer may include at least one of cellulose acetate, cellulose triacetate, and cellulose-2,5-acetate. The acryl-based polymer may include polymethylmethacrylate (PMMA).

The absorption member 400 may further include a surfactant coated on a hydrophobic polymer. The hydrophobic polymer may include at least one of PE, PP, and silicone. The surfactant may include at least one of Triton-X 100 having hydrophilic lipophilic balance (HLB) of 10 or more, pluronic, sodium lauryl sulfate (SLS).

The microfluidic device 10 may further include a cover 300 disposed on the platform 11 so as to cover the absorption member 400. In detail, the cover 300 may be coupled onto a first substrate 11a so as to cover the absorption member 400. In other words, the absorption member 400 may be disposed in a gap 310 so as to absorb the sample that remains in the gap 310 (see FIG. 4) formed between the cover 300 and the sample injection hole 14.

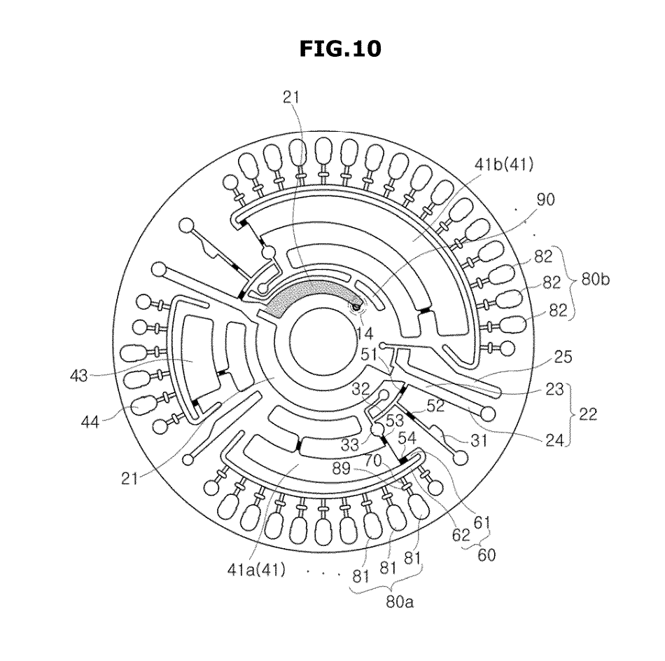

FIG. 10 is a plan view of the entire structure of the microfluidic device in accordance with still another exemplary embodiment. Reference numbers correspond to those structures describes in FIGS. 1-9.

The microfluidic device 10 includes a platform 11 having a sample injection hole 14 and a sample chamber 21 that is disposed in the platform 11 so as to accommodate the sample introduced through the sample injection hole 14 and that communicates with the sample injection hole 14.

As illustrated by the shaded portion in FIG. 10, at least part of the platform 11 may be treated to have hydrophilicity. Preferably, the sample chamber 21 may be treated to have hydrophilicity. That is, inner walls of the sample chamber 21 may be treated to have hydrophilicity.

At least part of the platform 11 is hydrophilic-treated so that the sample may be smoothly injected in a direction of an inside of the sample chamber 21 through the sample injection hole 14.

At least part of the platform 11 may be hydrophilic-surface treated. For example, at least part of the platform 11 may be hydrophilic-surface treated using a plasma gas.

At least part of the platform 11 may be hydrophilic-treated using double injection. That is, at least part of the platform 11 may be double-injected using different materials having hydrophilicity when the platform 11 is formed. A material that may be double-injected may include polymer having a contact angle of 70 degrees or less.

Hydrophilic treatment (see FIG. 10) of at least part of the above-described cover 300 (see FIG. 4), the absorption member 400 (see FIG. 9), and the platform 11 are formed to prevent the platform 11 from being contaminated by the remaining sample that remains in an outside of the sample injection hole 14. At least one of hydrophilic treatments of at least part of the cover 300, the absorption member 400, and the platform 11 may be applied to the microfluidic device 10.

FIG. 11 illustrates a sample testing device that uses the microfluidic device in accordance with an exemplary embodiment. Reference numbers correspond to those structures describes in FIGS. 1-10.

The sample testing device may include a spindle motor 105 that rotates the microfluidic device 10, a data reading portion 130, a valve opening device 120, a testing portion 140, an input portion 110, an output portion 150, a diagnosis database 160, and a controller 170 that controls each of the elements.

The spindle motor 105 may rotate the microfluidic device 10 and may stop or rotate the microfluidic device 10 so as to reach a particular position.

The spindle motor 105 may include a motor drive (not shown) that may control an angular position of the microfluidic device 10. For example, the motor drive may be a step motor or a direct current (DC) motor.

The data reading portion 130 may be a bar code reader, for example. The data reading portion 130 reads data stored in a bar code (not shown), transmits the read data to the controller 170, and the controller 170 operates each element based on the read data and drives the sample testing device.

The valve opening device 120 that is provided to open/close the valves 51, 52, 53, and 54 of the microfluidic device 10 may include the external energy source 122 and movement units 124 and 126 that transfer the external energy source 122 to the valves 51, 52, 53, and 54 that need to be opened.

The external energy source 122 that radiates electromagnetic waves may be a laser light source that radiates laser beams or a light emitting diode or a Xenon lamp that radiates visible rays or infrared rays. When the external energy source 122 is a laser light source, the external energy source 122 may include at least one laser diode.

The movement units 124 and 126 that adjust the position of the external energy source 122 so as to radiate concentrated energy onto a desired region of the microfluidic device 10, i.e., onto the valves 51, 52, 53, and 54, by adjusting a position or direction of the external energy source 122, may include a driving motor 124 and a gear portion 126 on which the external energy source 122 is mounted and which moves the external energy source 122 to upper sides of the valves 51, 52, 53, and 54 that need to be opened, according to rotation of the driving motor 124. The movement units 124 and 126 may be implemented using various mechanisms.

The testing portion 140 may include at least one light emitting portion 141 and a light receiving portion 143 that is disposed to correspond to the light emitting portion 141 and receives light transmitted through the reaction chambers 81 and 82 of the microfluidic device 10.

The light emitting portion 141 is a light source that is turned on or off at a predetermined frequency. Examples of adoptable light sources may include a semiconductor light emitting device, such as a light emitting diode (LED) or a laser diode (LD), and a gas discharge lamp, such as a halogen lamp or Xenon lamp.

Also, the light emitting portion 141 is placed in a position in which light emitted from the light emitting portion 141 may reach the light receiving portion 143 through the reaction chambers 81 and 82.

The light receiving portion 143 that generates electrical signals according to intensity of incident light, may include at least one of a depletion layer photo diode, an avalanche photo diode (APD), and photomultiplier tubes (PMT), for example.

The controller 170 controls the spindle motor 105, the data reading portion 130, the valve opening device 120, and the testing portion 140 to smoothly perform an operation of the sample testing device, searches the diagnosis database 160, compares information detected from the testing portion 140 with the diagnosis database 160, and determines the information, thereby checking whether a disease exists in blood accommodated in the reaction chambers 81 and 82 of the microfluidic device 10.

The input portion 110 is used to input testing items that may be tested according to the type of the sample introduced into the microfluidic device 10 and/or the type of the injected sample. The input portion 110 may be provided in the sample testing device in the form of a touch screen.

The output portion 150 is used to output diagnosis contents and completion of a diagnosis to the outside. The output portion 150 may be configured as a visual output means, such as a liquid crystal display (LCD), an auditory output means, such as a speaker, or an audio-visual output means.

The exemplary embodiments may be applied to both the microfluidic device 10 that uses centrifugal force and a microfluidic device 10a that uses a fluid analysis cartridge. Hereinafter, the microfluidic device that uses the fluid analysis cartridge will be described.

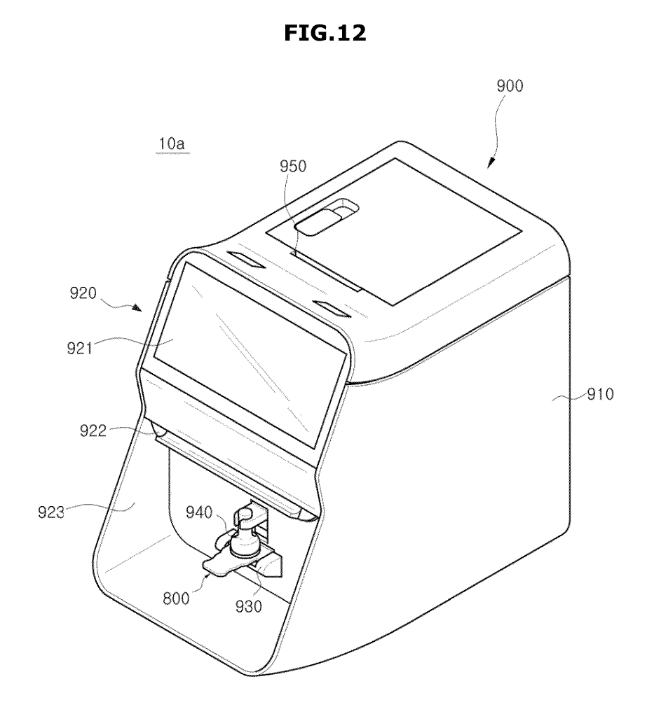

FIG. 12 is a perspective view of a microfluidic device in accordance with another exemplary embodiment. Hereinafter, a redundant description with FIGS. 1 through 11 may be omitted.

As illustrated in FIG. 12, the microfluidic device 10a may include a fluid analysis cartridge 800 and a fluid analysis device 900 to which the fluid analysis cartridge 800 is coupled.

The fluid analysis device 900 may include a housing 910 that constitutes an exterior and a door module 920 that is disposed in front of the housing 910.

The door module 920 may include a display portion 921, a door 922, and a door frame 923. The display portion 921 and the door 922 may be disposed in front of the door frame 923. The display portion 921 may be placed at an upper portion of the door 922. If the door 922 is slidably provided and slides to be opened, the door 922 may be provided to be placed in rear of the display portion 921.

Information regarding sample analysis contents and a sample analysis operating state may be displayed on the display portion 921. A mounting member 930 on which the fluid analysis cartridge 800 for accommodating a fluid sample may be mounted, may be provided at the door frame 923. A user may perform an analysis operation after sliding the door 922 upwardly, opening the door 922 and then mounting the fluid analysis cartridge 800 on the mounting member 930, and then sliding the door 922 downwardly and closing the door 922.

The fluid sample is injected into the fluid analysis cartridge 800, and a reaction between the fluid sample and the reagent occurs in a testing unit 820. The fluid analysis cartridge 800 is inserted into the mounting member 930, and a pressurizing member 940 pressurizes the fluid analysis cartridge 800 so that the fluid sample in the fluid analysis cartridge 800 may be introduced into the testing unit 820.

Also, an output portion 950 that outputs a testing result as a separate printed material, may be further provided separately from the display portion 921.

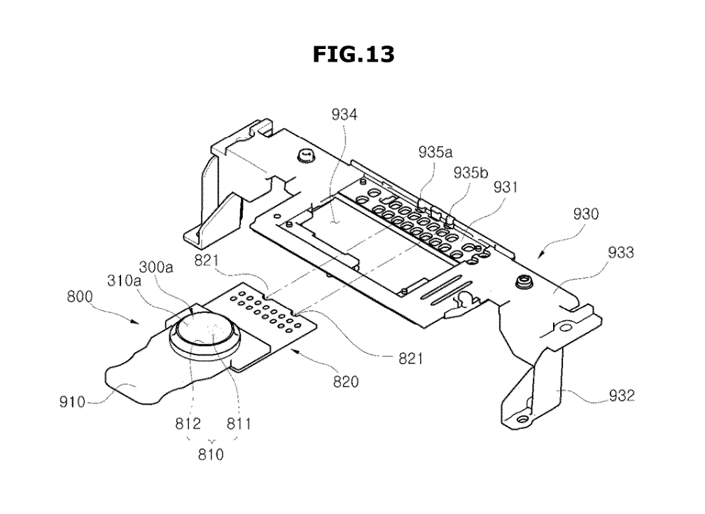

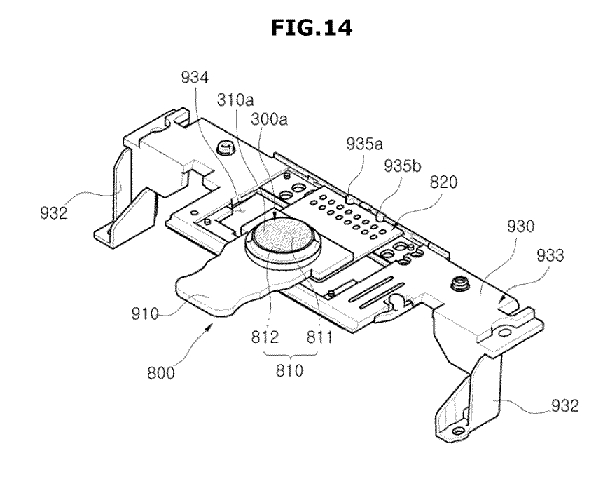

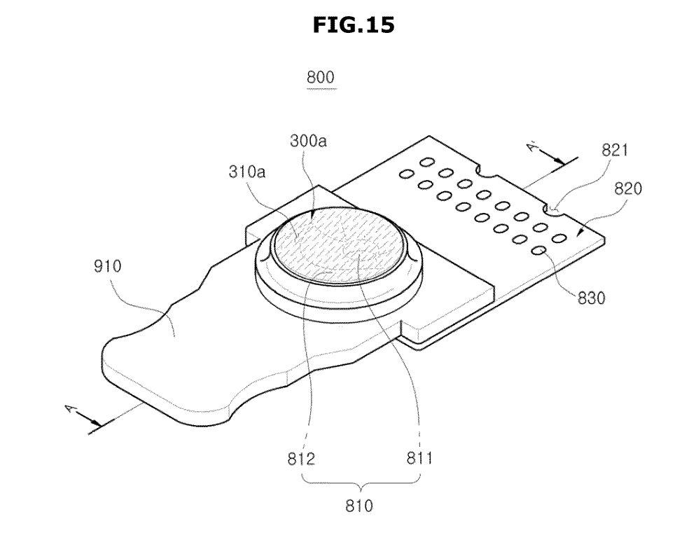

FIG. 13 is an exploded view of a fluid analysis cartridge and a mounting member of a fluid analysis device to which the fluid analysis cartridge is coupled, of the microfluidic device in accordance with another exemplary embodiment, and FIG. 14 is a view of a state in which the fluid analysis cartridge is coupled to the mounting member of the fluid analysis device to which the fluid analysis cartridge is coupled, of the microfluidic device in accordance with another exemplary embodiment. FIG. 15 is a view of the fluid analysis cartridge of the microfluidic device in accordance with another exemplary embodiment.

As illustrated in FIGS. 13 through 15, a fluid analysis cartridge 800 may be inserted into a mounting member 930 of a fluid analysis device 900. The mounting member 930 may include a seating portion 931 on which the fluid analysis cartridge 800 is mounted, and a support portion 932 that supports the mounting member 930 within the fluid analysis device 900. The support portion 932 may be provided to extend to both sides of a body 933 of the mounting member 930, and the seating portion 931 may be provided in the middle of the body 933. A slit 934 may be formed in rear of the seating portion 931 so as to prevent an error that may occur when a testing result of the fluid sample is measured using the testing unit 820.

The mounting member 930 may include contact portions 935a and 935b that are in contact with the fluid analysis cartridge 800. The testing unit 820 of the fluid analysis cartridge 800 may include a recessed portion 821 having a shape corresponding to the contact portions 935a and 935b. The recessed portion 821 and the contact portions 935a and 935b may be in contact with each other. According to an exemplary embodiment, two recessed portions 821 may be provided. Thus, two contact portions 935a and 935b may be provided.

The fluid analysis cartridge 800 may include a housing 910 that constitutes an exterior and the testing unit 820 in which a reaction between the fluid and the reagent occurs.

The housing 910 may include a grasping portion which supports the fluid analysis cartridge 800 and in which simultaneously, the user may grasp the fluid analysis cartridge 800. The grasping portion is formed in the form of a streamlined protrusion so that the user may stably grasp the fluid analysis cartridge 800.

Also, a fluid supply portion 810 to which the fluid sample is supplied, may be provided in the fluid analysis cartridge 800. The fluid supply portion 810 may include a supply hole 811 through which the fluid sample is introduced into the testing unit 820, and a supply-assisting portion 812 that assists with the supply of the fluid. The fluid that may be tested by the fluid analysis device 900 is supplied to the fluid supply portion 810, and examples of the fluid that is an object to be tested may include a biological sample, such as a body fluid including blood, a tissue fluid, and a lymph fluid, salvia, and urine, or an environmental sample for water quality management or soil management. However, exemplary embodiments are not limited thereto.

The supply hole 811 may be formed in a circular shape. However, exemplary embodiments are not limited thereto, and the supply hole 811 may be formed in a polygonal shape. The user may drop the fluid sample onto the fluid supply portion 810 using a tool, such as a pipette or spoid. The supply-assisting portion 812 is formed around the supply hole 811 to be inclined in a direction of the supply hole 811 so that the fluid sample dropped onto the circumference of the supply hole 811 may flow into the supply hole 811. In detail, when the user does not accurately drop the fluid sample into the supply hole 811 and part of the fluid sample is dropped onto the circumference of the supply hole 811, the fluid sample dropped onto the circumference of the supply hole 811 may be introduced into the supply hole 811 due to inclination of the supply-assisting portion 812.

Also, the supply-assisting portion 812 may assist with the supply of the fluid sample and may prevent contamination of the fluid analysis cartridge 800 caused by the wrongly-supplied fluid sample. In detail, even when the fluid sample is not accurately introduced into the supply hole 811, the supply-assisting portion 812 on the circumference of the supply hole 811 prevents the fluid sample from flowing into the testing unit 820 or the grasping portion so that contamination of the fluid analysis cartridge 800 caused by the fluid sample may be prevented and the fluid sample that may be harmful to the human body may be prevented from being in contact with the user.

According to the drawings, the fluid supply portion 810 includes only one supply hole 811. However, exemplary embodiments are not limited thereto, and the fluid supply portion 810 may include a plurality of supply holes 811. When the plurality of supply holes 811 is provided, testing may be simultaneously performed on a plurality of different fluid samples in one fluid analysis cartridge 800. Here, the plurality of different fluid samples have the same type but their sources may be different from each other, or the plurality of different fluid samples may have different types and sources or may have the same type and source but their states may be different from each other.

As described above, the housing 910 has a shape in which the housing 910 implements a particular function and may be in contact with the fluid sample. Thus, the housing 910 may be formed of a material that may be easily formed and is chemically and biologically inactive. For example, the housing 910 may be formed of various materials, such as a plastic material, for example, acryl, such as PMMA, polysiloxane, such as PDMS, polycarbonate (PC), linear low density polyethylene (LLDPE), acrylonitrile butadiene styrene (ABS), and cyclo olefin copolymer (COC), glass, mica, silica, and a semiconductor wafer. However, the materials are just examples of materials that may be used to form the housing 910, and exemplary embodiments are not limited thereto. Any type of material having chemical and biological stability and mechanical machinability may be used to form the housing 910 according to an exemplary embodiment.

The fluid analysis cartridge 800 may be provided so that the testing unit 820 may be coupled or bonded to the fluid analysis cartridge 800. The fluid injected through the fluid supply portion 810 may be introduced into the testing unit 820, and the reaction between the fluid and the reagent occurs in the testing unit 820 so that testing may be performed. The testing unit 820 includes a testing portion 830, and the reagent that reacts with the fluid is accommodated in the testing portion 830.

The fluid supply portion 810 to which the fluid sample is supplied, may be provided in the fluid analysis cartridge 800. In detail, the fluid supply portion 810 may be provided at the housing 910.

The fluid analysis cartridge 800 may further include a cover 300a disposed over the fluid supply portion 810.

The cover 300a may be disposed at the housing 910 so as to be placed over the supply hole 811.

Also, the cover 300a may be disposed at the supply-assisting portion 812 so as to be placed over the supply hole 811.

A gap 310a may be formed between the fluid supply portion 810 and the cover 300a.

The cover 300a may be coupled to an outer surface of the housing 910. In detail, the cover 300a may be coupled onto the housing 910 so as to cover the supply hole 811.

Also, the cover 300a may be coupled to an outer surface of the fluid supply portion 810. In detail, the cover 300a may be coupled onto the fluid supply portion 810 so as to cover the supply hole 811.

The cover 300a may be disposed on the supply hole 811 and is not limited to the above example.

The sample that flows backward through the supply hole 811 remains in the supply hole 811, in the cover 300a, or in the gap 310a formed between the fluid supply portion 810 and the cover 300a due to capillary force. The sample accommodated in the gap 310a is moved to the testing unit 820 as the pressurizing member 940 pressurizes the fluid analysis cartridge 800. In this way, the cover 300a is disposed on the supply hole 811 or the fluid supply portion 810 so that a level of the sample that remains in the gap 310a may be maintained to be lower than that of the fluid supply portion 810. As a result, the remaining sample may be prevented from overpassing the fluid supply portion 810 and being scattered.

The cover 300a may include a material having adhesion. That is, the cover 300a may be adhered onto the housing 910 or the fluid supply portion 810.

The cover 300a may include a cutting line (not shown)(see FIG. 7).

The cover 300a may include a fluid supply portion sign (not shown)(see FIG. 8).

An absorption member (not shown)(see FIG. 9) may be provided in the fluid supply portion 810 so as to absorb the sample that overpasses the supply hole 811. The cover 300a may be disposed on the housing 910 or the fluid supply portion 810 so as to cover the absorption member (not shown). When the absorption member (not shown) is disposed on the fluid supply portion 810, the cover 300a may also be omitted.

At least part of the fluid supply portion 810 may be treated to have hydrophilicity (see FIG. 10). That is, inner walls of the fluid supply portion 810 may be treated to have hydrophilicity. This is to allow the sample to be smoothly injected through the supply hole 811.

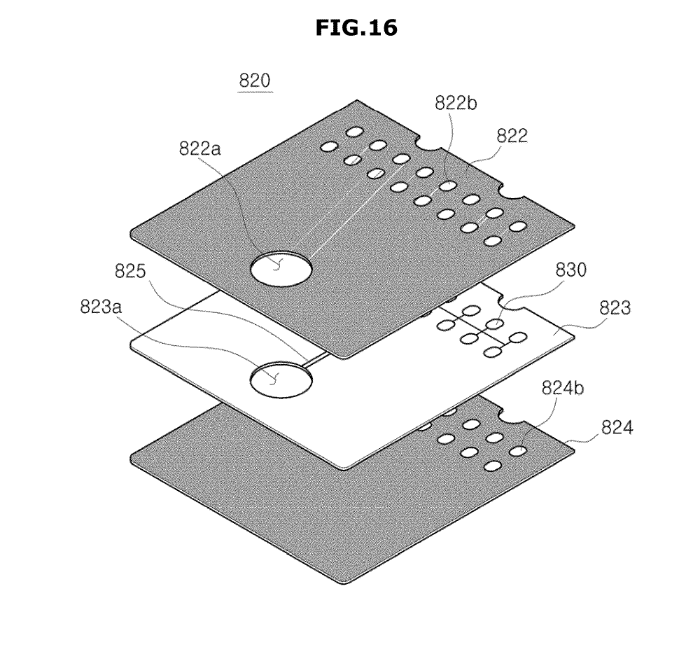

FIG. 16 is an exploded view of a testing unit of the fluid analysis cartridge of the microfluidic device in accordance with another exemplary embodiment.

As illustrated in FIG. 16, a testing unit 820 of a fluid analysis cartridge 800 may be formed to have a structure in which three plates 822, 823, and 824 are bonded to each other. The three plates 822, 823, and 824 may be divided into an upper plate 822, an intermediate plate 823, and a lower plate 824. The upper plate 822 and the lower plate 824 may be printed with a light-blocking ink and protect the fluid sample that is being moved to a testing portion 830, from external light, or may prevent an error that may occur when optical characteristics are measured by the testing portion 830.

Each of the upper plate 822 and the lower plate 824 may have a thickness of 10 to 300 μm. The intermediate plate 823 may have a thickness of 50 to 300 μm.

A film used to form the upper plate 822 and the lower plate 824 of the testing unit 820 may be selected from the group consisting of a polyethylene film, such as a very low density polyethylene (VLDPE), linear low density polyethylene (LLDPE), low density polyethylene (LDPE), medium density polyethylene (MDPE), and high density polyethylene (HDPE), a polypropylene (PP) film, a polyvinyl chloride (PVC) film, a polyvinyl alcohol (PVA) film, a polystyrene (PS) film, and a polyethylene terephthalate (PET) film. However, this is just an example, and any type of film that is chemically and biologically inactive and has mechanical machinability may be a film used to form the upper plate 822 and the lower plate 824 of the testing unit 820.

The intermediate plate 823 of the testing unit 820 may be formed of a porous sheet, unlike in the upper plate 822 and the lower plate 824. Examples of the porous sheet that may be used as the intermediate plate 823 may include one or more among cellulose acetate, nylon 6.6, nylon 6.10, and polyethersulfone. Since the intermediate plate 823 is provided as the porous sheet, the intermediate plate 823 itself serves as a vent, and the fluid sample may be moved within the testing unit 820 without using a separate driving source. Also, when the fluid sample is hydrophilic, the intermediate plate 823 may be coated with a hydrophobic solution so as to prevent the fluid sample from permeating into the intermediate plate 823.

An inlet 822a through which the fluid sample is introduced, may be formed on the upper plate 822, and a region 822b of the upper plate 822 that corresponds to the testing portion 830 may be transparently treated. A region 824b of the lower plate 824 that corresponds to the testing portion 830 may be transparently treated. This is to measure absorbance, i.e., optical characteristics of a reaction that occurs in the testing portion 830.

An inlet 823a through which the fluid sample is introduced, may be formed on the intermediate plate 823, and the inlet 822a of the upper plate 822 and the inlet 823a of the intermediate plate 823 may overlap each other so that an inlet 820a of the testing unit 820 may be formed. Various reactions for fluid analysis may occur in the testing unit 820. When blood is used as the fluid sample, a reagent that reacts with a particular component of the blood, in particular, blood plasma and that is colored or discolored may be accommodated in the testing portion 830 so that color represented in the testing portion 830 may be optically detected and represented as values. It may be checked whether the particular component exists in the blood or a ratio of the particular component, using the values.

Also, a flow path 825 that connects the inlet 823a and the testing portion 830 may be formed on the intermediate plate 823.

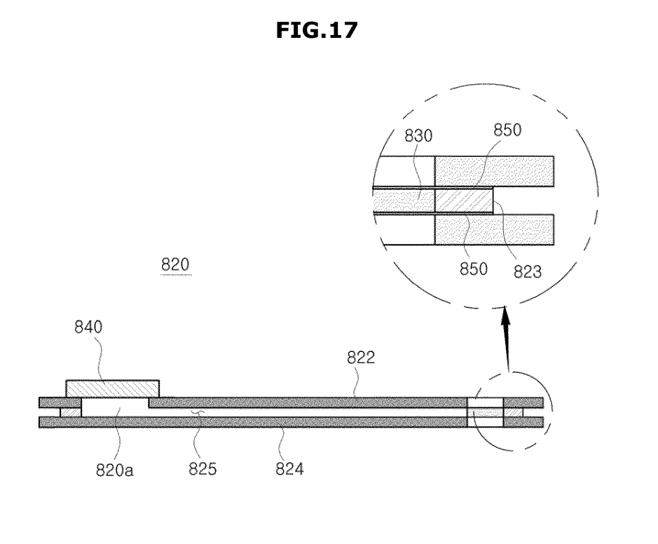

FIG. 17 is a cross-sectional view of the testing unit of the fluid analysis cartridge taken along direction AA′ of FIG. 15.

As illustrated in FIG. 17, the fluid analysis cartridge 800 may be formed in such a way that the testing unit 820 may be bonded to a lower portion of the housing 910. In detail, the testing unit 820 may be bonded to the lower side of the fluid supply portion 810. In detail, the testing unit 820 may be bonded to a lower side of the fluid supply portion 810 in which the supply hole 811 is formed. A pressure sensitive adhesive (PSA) may be used to bond the housing 910 and the testing unit 820. The PSA has characteristics that it may be adhered to an object to be adhered with a small pressure of acupressure at room temperature, does not cause cohesive failure when it is peeled, and does not leave a residue on the surface of the object to be adhered. However, the housing 910 and the testing unit 820 may not be bonded to each other using only the PSA but may be bonded to each other using other double-sided adhesive than the PSA or while being inserted into a groove.

The fluid sample introduced through the supply hole 811 passes through a filtering portion 840 and is introduced into the testing unit 820, as illustrated in FIG. 17. The filtering portion 840 may be inserted into the supply hole 811 of the housing 910.

The filtering portion 840 may include at least one or more porous membranes including a plurality of pores so as to filter at least a material having a predetermined size within the fluid sample. According to an exemplary embodiment, the filtering portion 840 may include a two-layered filter. For example, a first filter may be configured as a glass fiber, a nonwoven fabric, or an absorbent filter. A second filter may be configured of PC, polyethersulfone (PES), PE, polysulfone (PS), and polyacrylsulfone (PASF).

As described above, when the filtering portion 840 is formed as a double layer, the filtering portion 840 may perform filtering on the fluid sample that passes through an upper filter, in a lower filter once more. Also, when a large amount of particles larger than the pore size of the filtering portion 840 are introduced at a time, the filtering portion 840 may be prevented from being torn or damaged. However, exemplary embodiments are not limited thereto, and the filtering portion 840 may be provided to include a triple layer or three or more layers. In this case, a filtering function on the fluid sample is further reinforced, and stability of the filtering portion 840 is further improved. Each of the filtering portion 840 may be processed using an adhesive material (not shown), such as a double-sided adhesive.

The testing unit 820 may include the inlet 820a through which the fluid sample that passes through the filtering portion 840 is introduced, the flow path 825 on which the introduced fluid sample is moved, and the testing portion 830 in which a reaction between the fluid sample and a reagent occurs.

The upper plate 822, the intermediate plate 823, and the lower plate 824 may be bonded to each other using a double-sided tape 850. In detail, the double-sided tape 850 may be attached to top and bottom surfaces of the intermediate plate 823 so that the upper plate 822, the intermediate plate 823, and the lower plate 824 may be bonded to one another.

As described above, in a microfluidic device according to the one or more exemplary embodiments, a recessed portion is formed in a platform so that a remaining sample that remains in a periphery of a sample injection hole can be guided to a predetermined position. Thus, various components of a sample testing device can be prevented from being contaminated by the remaining sample, or a tester can be prevented from being in direct contact with the remaining sample.

A cover is disposed over the sample injection hole so that a gap may be formed between the sample injection hole and the cover. Thus, the remaining sample can be prevented from overflowing toward an outside of the recessed portion due to capillary force that acts within the gap.

An absorption member is disposed on the sample injection hole so that the amount of the remaining sample that remains around the periphery of the sample injection hole can be reduced. Thus, an error of a resultant value of the microfluidic device that may be caused by the remaining sample can be reduced.

At least part of the platform is formed to have hydrophilicity so that the remaining sample can be prevented from remaining in an outer surface of the platform.

Although a few exemplary embodiments have been shown and described, it would be appreciated by those skilled in the art that changes may be made in these exemplary embodiments without departing from the principles and spirit of exemplary embodiments, the scope of which is defined in the claims and their equivalents.

What is claimed is:

1. A microfluidic device comprising:
a platform comprising:
a sample injection hole,
at least one chamber configured to accommodate a sample introduced through the sample injection hole,
at least one channel connected to the at least one chamber; and
a cover disposed over the sample injection hole,
wherein a gap is disposed between the sample injection hole and the cover.

2. The microfluidic device of claim 1, wherein the platform is rotatably disposed about a rotation axis, and the gap comprises a recessed portion formed in the platform recessed downwardly in a direction of the rotation axis, and
wherein the sample injection hole is disposed within the recessed portion.

3. The microfluidic device of claim 2, wherein an opening connected with the recessed portion is formed in the platform, and
the microfluidic device further comprises a remaining sample accommodation portion disposed beneath the opening, and configured to receive an amount of overflow sample material through the opening.

4. The microfluidic device of claim 3, wherein the sample accommodated in the recessed portion is moved to the remaining sample accommodation portion via the opening due to centrifugal force.

5. The microfluidic device of claim 3, wherein the platform comprises a bump, the bump protruding upwardly from the top surface of the platform, and
the bump is spaced apart from the recessed portion, and the opening is disposed between the bump and the recessed portion.

6. The microfluidic device of claim 5, wherein the bump is disposed along a circumference of the opening.

7. The microfluidic device of claim 1, wherein the cover is adhered onto the platform.

8. The microfluidic device of claim 1, wherein the cover comprises a cutting line positioned to correspond to the sample injection hole.

9. The microfluidic device of claim 1, wherein the cover comprises a sample injection hole mark corresponding to a position of the sample injection hole.

10. The microfluidic device of claim 1, wherein the at least one chamber comprises a sample chamber configured to accommodate the sample introduced through the sample injection hole, and
the sample chamber including at least one ledge positioned near the sample injection hole to limit a degree of insertion of a sample injection device introduced through the sample injection hole.

11. The microfluidic device of claim 10, wherein the at least one ledge is disposed at an inner wall of the sample chamber and protrudes into the sample chamber.

12. The microfluidic device of claim 10, wherein the at least one ledge includes a first ledge and a second ledge, the second ledge protruding into the sample chamber to a degree different from a protruding degree of the first ledge and the first and second ledges are disposed at different heights in the sample chamber.

13. The microfluidic device of claim 1, wherein at least part of the platform is hydrophilic.

14. The microfluidic device of claim 1, wherein the at least one chamber comprises a sample chamber configured to accommodate the sample introduced through the sample injection hole, and
the sample chamber is hydrophilic.

15. The microfluidic device of claim 1, wherein an absorption member is disposed in the gap to absorb the sample remaining in the gap, and
the absorption member comprises a porous material.

16. A microfluidic device comprising:
a platform having a rotation axis, the platform comprising:
a sample injection hole,
at least one chamber configured to accommodate a sample introduced through the sample injection hole,
at least one channel connected to the at least one chamber, and
a recessed portion disposed downwardly in a direction of the rotation axis; and
an absorption member disposed in the recessed portion to absorb sample material that overflows from the sample injection hole.

17. The microfluidic device of claim 16, wherein the platform includes an opening disposed adjacent to the sample injection hole in a radial direction away from a center part of the platform, and
the microfluidic device further comprises a remaining sample accommodation portion connected to the opening.

18. The microfluidic device of claim 17, wherein the platform comprises a bump, the bump protruding upwardly from a top surface of the platform, and
the bump is disposed along a circumference of the opening sin a radial direction away from the rotation axis.

19. The microfluidic device of claim 18, wherein the recessed portion and the bump surround the opening discontinuously.

20. The microfluidic device of claim 16, wherein the absorption member is disposed on the recessed portion so as to cover the sample injection hole.

21. The microfluidic device of claim 16, wherein a sample injection device for injecting the sample through the sample injection hole passes through the absorption member and is inserted into the sample injection hole.

22. The microfluidic device of claim 16, wherein the absorption member comprises a hydrophilic material.

23. The microfluidic device of claim 16, further comprising a cover disposed on the platform to cover the absorption member.

24. A microfluidic device comprising:
a platform comprising:
a sample injection hole; and
a sample chamber configured to accommodate a sample injected through the sample injection hole and connected with the sample injection hole,
wherein at least part of the platform is hydrophilic.

25. The microfluidic device of claim 24, wherein inner walls of the sample chamber are hydrophilic.

26. A microfluidic device comprising:
a platform comprising:
a recessed portion,
a sample injection hole formed in the recessed portion and abutting a convex surface,
a chamber configured to accommodate a sample introduced through the sample injection hole, and
an opening connected to the recessed portion.

27. The microfluidic device of claim 26, the microfluidic device further comprising a remaining sample accommodating portion disposed beneath the opening and configured to receive an amount of overflow sample material through the opening.

28. The microfluidic device of claim 26, wherein the at least one chamber comprises a sample chamber configured to accommodate the sample introduced through the sample injection hole, and
the sample chamber including at least one ledge positioned near the sample injection hole to limit a degree of insertion of a sample injection device introduced through the sample injection hole.
